(19) United States
(12) Patent Application Publication
(10) Pub. No.: US 2026/0080759 A1
(43) Pub. Date: Mar. 19, 2026

(54) Community Alert System

(71) Applicants: John Parks, Macon, MO (US); Cindy Parks, Macon, MO (US)

(72) Inventors: John Parks, Macon, MO (US); Cindy Parks, Macon, MO (US)

(21) Appl. No.: 18/889,295

(22) Filed: Sep. 18, 2024

(51) Int. Cl. G08B 7/06; G08B 17/10; G08B 21/14; G08B 25/00; G08B 25/10

(52) U.S. Cl. CPC G08B 7/06; G08B 17/10; G08B 21/14; G08B 25/009; G08B 25/10

(57) ABSTRACT

An alarm includes a body with connections to electrical power powered by a trigger of the alarm. The alarm includes a red strobe light and a blue strobe light and a speaker in the body, each configured to draw power from the body connections. The alarm includes a wireless transceiver configured to draw power from the body connections and interface with the strobe lights, the speaker and the alarm trigger. Embodiments of the body connections include a light bulb cap, a socket and an electrical extension there between. The disclosure is also triggered manually, remotely as single or ganged with other alarms including fire, smoke, water, security and medical alarms.

### BACKGROUND

In the United States, average response time is 8 minutes, 59 seconds away. Ambulance response time for a stroke is 18 minutes and in some cities 50 minutes if qualified personnel even come. Furthermore, Police departments are shrinking due to labor shortage. Police have to prioritize your call due to the emergency which causes delays. For example, the average response time in New York is 16 minutes. Emergency responders have to call people in from other areas due to volume.

Furthermore, older adults are more likely to fall. Nursing homes have an average 2.6 falls per person per year as an example. In a heart attack or a stroke situation when they can't talk, one can press a button if not dial 911. Additionally, Over 1 million Americans suffer from slip, trip or fall injuries and more than 17,000 will die due to these injuries. A device is needed to help first responders locate the house faster. A device is also needed to deter burglars, rapists and unwanted intruders to avoid deaths when no one is aware people are dying in their home or business.

### SUMMARY

An alarm includes a body with connections to electrical power powered by a trigger of the alarm. The alarm includes a red strobe light and a blue strobe light and a speaker in the body, each configured to draw power from the body connections. The alarm includes a wireless transceiver configured to draw power from the body connections and interface with the strobe lights, the speaker and the alarm trigger. Embodiments of the body connections include a light bulb cap, a socket and an electrical extension there between. The disclosure is also triggered manually, remotely as single or ganged with other alarms including fire, smoke, water, security and medical alarms.

### BRIEF DESCRIPTION OF THE DRAWINGS

FIG. 1 is a perspective view of the light socket strobe alarm in accordance with an embodiment of the present disclosure.

FIG. 2 is an elevational view of the solar light strobe alarm in accordance with an embodiment of the present disclosure.

FIG. 3 is a side view of the solar light strobe alarm in accordance with an embodiment of the present disclosure.

FIG. 4 is a plan view of an implementation of the light socket strobe alarm in accordance with an embodiment of the present disclosure.

FIG. 5 is a front elevational view of the light socket strobe alarm in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

The community alert system alerts neighbors and family when there is an emergency such as: Health, burglary, fire or any emergency. The system is mounted externally and internally in the home or business with little to no wiring or maintenance. The system is either activated by the home owner, resident or business owner or by the smoke detector or carbon dioxide detector in an emergency. Parts include: 1) Red and blue strobe lights either solar or hard wired into current porch light, 2) Inside alarms, 3) Outside horn or alarm loud enough people can hear in homes, 4) speaker broadcasting help needed, 5) smoke alarms and 6) Carbon monoxide alarms. The disclosure interfaces with remote controls including Alexa, ADT, Life Alert necklace and ring doorbells including Arlo, and Honeywell remotes.

A user simply presses a button connected to the red and blue strobe lights hard wired in light sockets including a front porch. It screws into existing bulb sockets. The disclosure also acts as an inexpensive solar porch light easy to install with 2 screws. (or solar option red and blue strobe light mounted to the front of a house or roof). 3) This system needs to be connected to a horn and a speaker signaling help needed. 4) It could have multiple triggers to activate it. A light switch to one's porch light, a Remote control, Alexa, an app on one's phone, voice activated saying 911 help, life alert necklace, Ring doorbell, ADT, Honeywell fan remote controls, etc. 5) Inside alarms would sound 6) Alarm system is connected to every smoke alarm and fire alarm in a residence to alert the neighbors they need help!

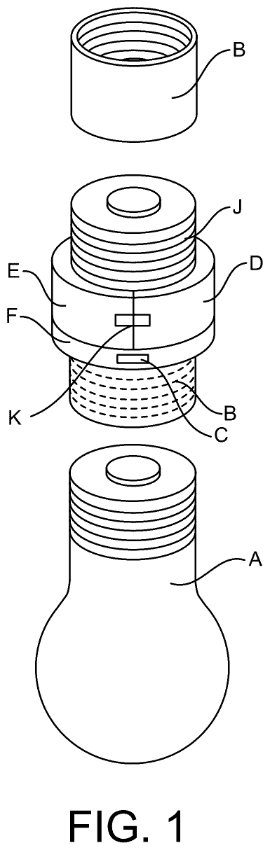

FIG. 1 is a perspective view of the light socket strobe alarm in accordance with an embodiment of the present disclosure. The view includes the light bulb A, the light socket B, the speaker C, the red strobe light D, the blue strobe light E, the solar panel F, the mounting bracket G or mounting threads J and the wireless transceiver K. The embodiment depicted takes an electrical power from the light socket. The transceiver K works via short waves and infrared waves and audible alarms of predetermined frequencies common to smoke alarms and carbon monoxide alarms for residential and business use.

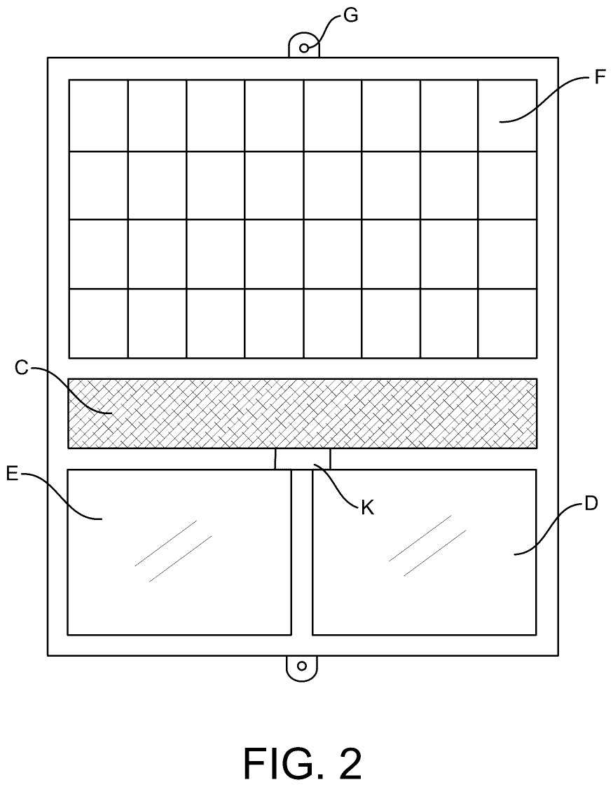

FIG. 2 is an elevational view of the solar light strobe alarm in accordance with an embodiment of the present disclosure. The view includes the speaker C, the red strobe light D, the blue strobe light E, the solar panel F, the mounting bracket G and the wireless transceiver K.

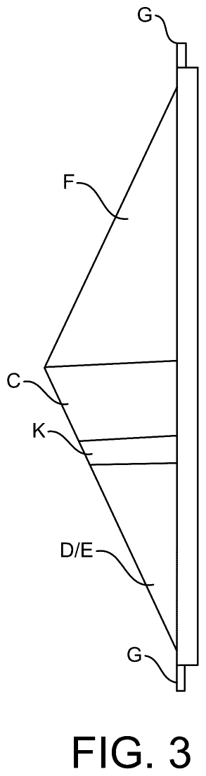

FIG. 3 is a side view of the solar light strobe alarm in accordance with an embodiment of the present disclosure. The view includes the speaker C, the strobe light D, the solar panel F, the mounting brackets G and the transceiver K. The conical arrangement as shown is independent of a light socket for implementation and requires an external power source (not shown).

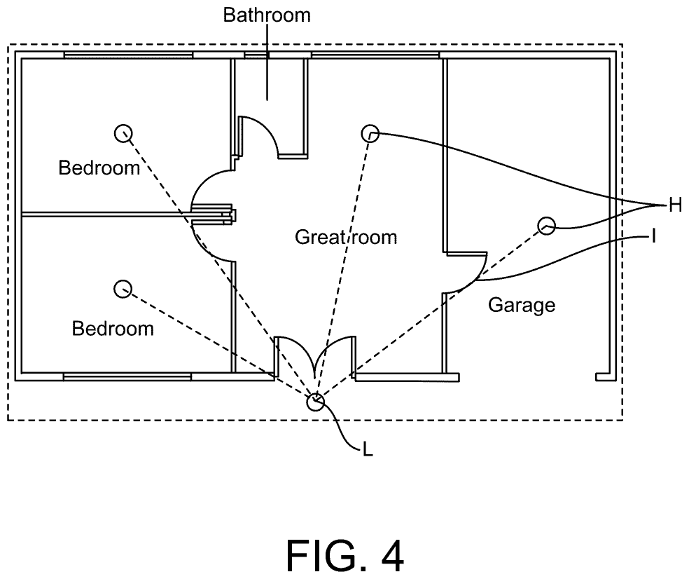

FIG. 4 is a plan view of an implementation of the light socket strobe alarm in accordance with an embodiment of the present disclosure. The view includes the smoke or carbon monoxide detectors H in rooms and garage of a residence wirelessly or with wires I to the disclosure L on a porch of the residence. The disclosure L is triggered by one of the smoke and carbon monoxide alarms H.

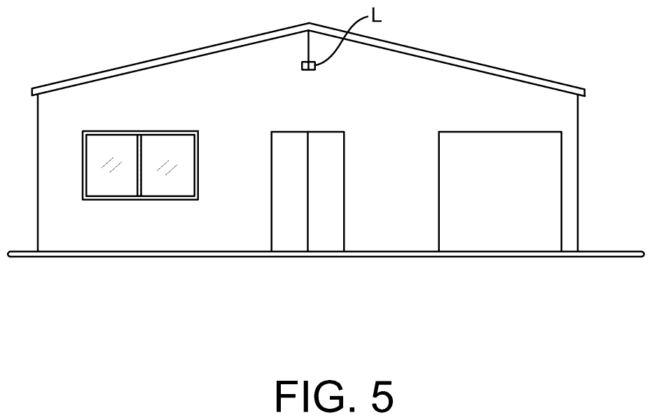

FIG. 5 is a front elevational view of the light socket strobe alarm in accordance with an embodiment of the present disclosure. The disclosure L is screwed into a porch light socket such as B and visible to neighbors in the community as an alarm that the residents need help in some way.

Embodiments of the disclosure include each of the red strobe light and the blue strobe light each having an LED element and a periodicity timer. Also, the body is cylindrical, the red strobe light and the blue strobe light are cylindrical and the speaker is cylindrical.

Other embodiments include a conical face of the body, a conical face of the red strobe light and the blue strobe lights, a speaker with a conical face, wherein the body further comprises a solar light panel with a conical face connected to the body and configured to source electrical power.

The disclosure closes the gap between the time 911 is called and potential neighbors arrive. The disclosure turns every porch light into an emergency response system to alert their neighbors. The disclosure simply screws into the socket of your current porch light. An average Emergency response is approximately 8 minutes and 59 seconds. However, neighbors are seconds to minutes away. Strangers stop and help car accidents everyday. This system is designed with the same thought that strangers, neighbors, off duty police, firemen, EMT, nurse, doctors, etc, would know there is an emergency and stop and help.

Disclosure distinguishing points: 1) Typically, nothing is external alerting your neighbors that you have a problem. 2) This is a red and blue flashing strobe light, horn or alarm, that even alerts emergency responders that can't see house numbers in the dark . . . which is very common. 3) It doubles the chance of life survival. 4) everybody has cameras now . . . but, nothing is alerting their neighbors they need help. 5) There is no system activating with smoke and CO alarms inside, as well as systems calling help needed outside, with flashing red and blue lights outside, that screw into your current porch light.

Further embodiments include the wireless transceiver configured to respond to a remote wireless communication from a residential security or medical alarm system. The trigger is activated by a smoke alarm system and by a carbon monoxide alarm system. The speaker is configured to amplify and/or synthesize a human voice message. The alarm trigger is activated by another alarm trigger within a range of the wireless transceiver. Also, the alarm trigger is activated by a wireless residential security alarm system. Additionally, the alarm trigger is activated by a wireless medical alarm system. The speaker is also a horn in disclosed embodiments.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. An alarm comprising:
a body comprising connections to electrical power, wherein the body connections are powered by a trigger of the alarm;
a red strobe light and a blue strobe light comprised in the body and each configured to draw power from the body connections;
a speaker comprised in the body and configured to draw power from the body connections; and
a wireless transceiver configured to draw power from the body connections and to interface with the strobe lights, the speaker and the trigger.

2. The alarm device of claim 1, wherein the body connections comprise a light bulb cap, a socket and an electrical extension there between.

3. The alarm device of claim 1, wherein each of the red strobe light and the blue strobe light each comprise an LED element and a periodicity timer.

4. The alarm device of claim 1, wherein the body is cylindrical.

5. The alarm device of claim 1, wherein the red strobe light and the blue strobe light are cylindrical.

6. The alarm device of claim 1, wherein the speaker is cylindrical.

7. The alarm device of of claim 1, wherein a face of the body is conical.

8. The alarm device of claim 1, wherein a face of the red strobe light and the blue strobe lights is conical.

9. The alarm device of claim 1, wherein a face of the speaker is conical.

10. The alarm device of claim 1, wherein the body further comprises a solar light panel connected to the body and configured to source electrical power.

11. The alarm device of claim 9, wherein the solar panel is cylindrical.

12. The alarm device of claim 9, wherein a face of the solar panel is conical.

13. The alarm device of claim 1, wherein the wireless transceiver responds to a remote wireless communication from a residential security, business security or medical alarm system.

14. The alarm device of claim 1, wherein the trigger is activated by a smoke alarm system.

15. The alarm device of claim 1, wherein the trigger is activated by a carbon monoxide alarm system.

16. The alarm device of claim 1, wherein the speaker is configured to amplify and/or synthesize a human voice message.

17. The alarm device of claim 1, wherein the alarm trigger is activated by another alarm trigger within a range of the wireless transceiver.

18. The alarm device of claim 1, wherein the alarm trigger is activated by a wireless residential security alarm system.

19. The alarm device of claim 1, wherein the alarm trigger is activated by a wireless medical alarm system.

20. The alarm device of claim 1, wherein the speaker is a horn.
